(19) United States
(12) Patent Application Publication
(10) Pub. No.: US 2026/0075146 A1
(43) Pub. Date: Mar. 12, 2026

(54) STORAGE MEDIUM, INFORMATION PROCESSING APPARATUS, AND INFORMATION PROCESSING METHOD

(71) Applicant: CANON KABUSHIKI KAISHA, Tokyo (JP)

(72) Inventor: NAO DOBASHI, Kanagawa (JP)

(21) Appl. No.: 19/324,745

(22) Filed: Sep. 10, 2025

(30) Foreign Application Priority Data
Sep. 11, 2024 (JP) 2024-157265

(51) Int. Cl. H04N 1/00; H04N 1/32

(52) U.S. Cl. CPC H04N 1/00395; H04N 1/32267; H04N 2201/0094

(57) ABSTRACT

An information processing apparatus is provided and executes accepting an input of a prompt by a user, and outputting image data generated by adding code information to an image generated by generative AI that uses the input prompt and input image data, in which the code information provides access to the input image data.

### BACKGROUND

### Field of the Technology

The present disclosure relates to a storage medium, an information processing apparatus, and an information processing method.

### Description of the Related Art

Japanese Patent Laid-Open No. 2023-034015 describes a scan system in which a QR code (registered trademark) is added to a black-and-white image generated by performing black-and-white scan of a color image, and a user can refer to the color image by reading the QR code.

In addition, in recent years, services using generative artificial intelligence (generative AI) have been rapidly developed, and a mechanism is being developed to allow a user to access a variety of services through a natural language input.

In a case where an image is edited by using the generative AI or a case where another image is generated based on a certain image by using the generative AI, a user may desire to check an image before the editing or a base image.

According to Japanese Patent Laid-Open No. 2023-034015, addition of the QR code to the black-and-white image has been considered in a case where the color image is converted into the black-and-white image, but it is not considered to add, in a case where an image is edited by using the generative AI or the like, code information for checking the image before the editing.

### SUMMARY

The present disclosure has been made in view of the above-described issue and aims to provide a technique with which it is possible to refer to an original image of an image generated by generative AI based on the image generated by the generative AI.

An information processing apparatus is provided and executes accepting an input of a prompt by a user, and outputting image data generated by adding code information to an image generated by generative AI that uses the input prompt and input image data, in which the code information provides access to the input image data.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of a system of the present disclosure.

FIG. 2 illustrates examples of hardware configurations of a computer, a smartphone, a generative AI server, and an ID management server of the present disclosure.

FIG. 3 illustrates an example of a hardware configuration of an MFP of the present disclosure.

FIG. 4 illustrates examples of software configurations of the computer, the smartphone, the generative AI server, and the ID management server of the present disclosure.

FIG. 5A illustrates examples of a screen displayed by a document processing application and a screen displayed on the smartphone.

FIG. 5B illustrates examples of the screen displayed by the document processing application and the screen displayed on the smartphone.

FIG. 6 illustrates an example of an instruction sentence which is transmitted by the computer to the generative AI server.

FIG. 7A illustrates an example of content before editing.

FIG. 7B illustrates an example of content after the editing.

FIG. 8 illustrates an example of information managed by the ID management server.

FIG. 9A is a sequence diagram illustrating an example of processing of a system of the present disclosure.

FIG. 9B is a sequence diagram illustrating an example of the processing of the system of the present disclosure.

FIG. 10 is a flowchart illustrating an example of processing of the generative AI server.

FIG. 11 illustrates an example of a software configuration of the MFP.

FIG. 12 illustrates an example of an LUI displayed on a display unit of the MFP.

FIG. 13A is a sequence diagram illustrating an example of the processing of the system of the present disclosure.

FIG. 13B is a sequence diagram illustrating an example of the processing of the system of the present disclosure.

### DESCRIPTION OF THE EMBODIMENTS

Hereinafter, embodiments will be described in detail with reference to the accompanying drawings. It is noted that the embodiments are not to limit the disclosure according to the scope of claims. A plurality of features are described in the embodiments, but not all the plurality of these features are necessarily essential to the disclosure, and the plurality of features may also be optionally combined.

### First Embodiment

### System Configuration

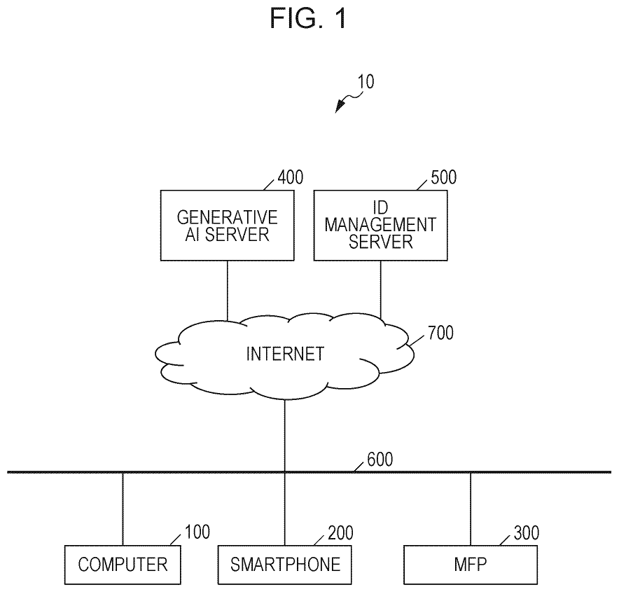

Hereinafter, a first embodiment of the present disclosure will be described. First, a network configuration of a print system according to the present embodiment will be described with reference to FIG. 1.

As illustrated in FIG. 1, a printing system 10 includes a computer 100 serving as a terminal apparatus, an information processing apparatus, or the like, a smartphone 200, a multi function peripheral (MFP) 300, a generative AI server 400, and an ID management server 500. For example, the computer 100, the smartphone 200, and the MFP 300 are arranged in an office and are connected to one another communicatively via an in-house network 600. The in-house network 600 is connected to an external Internet 700 via a router (not illustrated). Herein, the computer 100 is an example of the terminal apparatus or the information processing apparatus, and the generative AI server 400 and the ID management server 500 are examples of the information processing apparatus.

The generative AI server 400 is communicatively connected to the computer 100, the smartphone 200, the MFP 300, and the ID management server 500 via the Internet 700 and the in-house network 600. The generative AI server 400 is a server managed by a business operator which provides a generative AI service. The ID management server 500 is communicatively connected to the computer 100 and the generative AI server 400 via the Internet 700 and the in-house network 600. The ID management server 500 is a server managed by a business operator which provides a print service. It is noted that the computer 100, the smartphone 200, the generative AI server 400, and the ID management server 500 may be separate or may be integrated to exist on the same hardware. In addition, the in-house network 600 may be based on a wired connection or may be based on a wireless connection.

### Hardware Configuration

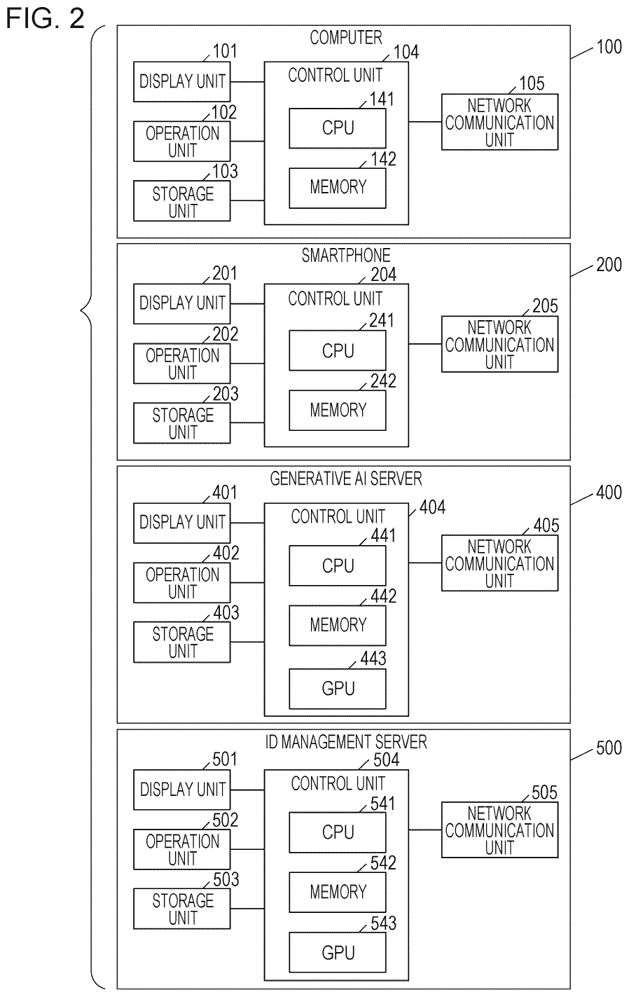

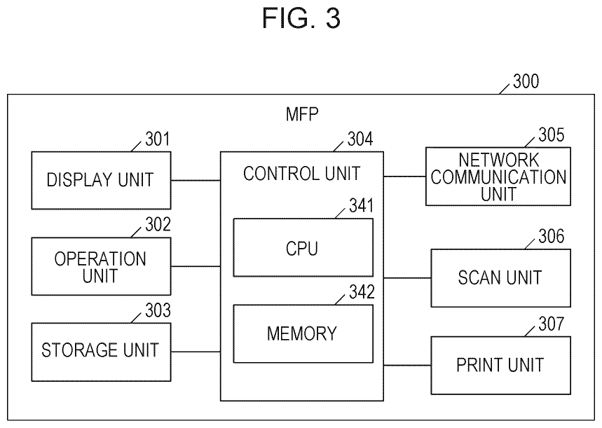

A hardware configuration of each of the apparatuses of the printing system 10 will be described with reference to FIG. 2 and FIG. 3. FIG. 2 illustrates hardware configurations of the computer 100, the smartphone 200, the generative AI server 400, and the ID management server 500. FIG. 3 illustrates a hardware configuration of the MFP 300.

As illustrated in FIG. 2, the computer 100 includes a display unit 101, an operation unit 102, a storage unit 103, a control unit 104, and a network communication unit 105, and these components are communicatively connected to one another. There is no particular limitation on the computer 100, and for example, a desktop or notebook personal computer, a tablet terminal, a smartphone, or the like can be applied as the computer 100. The control unit 104 is configured by including a central processing unit (CPU) 141 and a memory 142 and controls the entire computer 100.

The display unit 101 is constituted by, for example, a display such as a liquid crystal panel and can display an image or the like. The operation unit 102 is constituted, for example, by a mouse, a keyboard, or the like and can accept an input operation by a user. The storage unit 103 is constituted, for example, by a storage medium such as a hard disc drive or a solid state drive (SSD) and saves various types of programs (software) and the like used by the computer 100 to operate. The programs are loaded to the memory 142 when necessary and executed by the CPU 141. The programs include a program for the CPU 141 to execute each unit and each function of the printing system 10. It is noted that this program is not limited to a program saved in the computer 100. The programs may be saved, for example, in the generative AI server 400 or the ID management server 500 or may be distributed and saved in the computer 100, the generative AI server 400, and the ID management server 500. The network communication unit 105 is a network interface (I/F) and performs transmission and reception of data with an external apparatus via an external network.

Since a hardware configuration of the smartphone 200 is almost identical to a hardware configuration of the computer 100, a description of the hardware configuration of the smartphone 200 will be omitted in the present embodiment.

The generative AI server 400 includes a display unit 401, an operation unit 402, a storage unit 403, a control unit 404, and a network communication unit 405, and these components are communicatively connected to one another. The control unit 404 is configured by including a CPU 441, a memory 442, and a graphics processing unit (GPU) 443 and controls the entire generative AI server 400.

In this manner, since a hardware configuration of the generative AI server 400 is almost identical to the hardware configuration of the computer 100, a detailed description thereof will be omitted.

The ID management server 500 includes a display unit 501, an operation unit 502, a storage unit 503, a control unit 504, and a network communication unit 505, and these components are communicatively connected to one another.

The control unit 504 includes a CPU 541, a memory 542, and a GPU 543. Since a hardware configuration of the ID management server 500 is almost identical to the hardware configuration of the generative AI server 400, a detailed description thereof will be omitted.

As illustrated in FIG. 3, the MFP 300 serving as a printing apparatus, a scan apparatus, an image forming apparatus, or an image processing apparatus includes a display unit 301, an operation unit 302, a storage unit 303, a control unit 304, a network communication unit 305, a scan unit 306, and a print unit 307. These components are communicatively connected to one another. The control unit 304 is configured by including a CPU 341 and a memory 342 and controls the entire MFP 300. The scan unit 306 reads an image of an original to generate image data. The generated image data may be transmitted to the outside via the network communication unit 305. In addition, the print unit 307 may print an image on a sheet based on the generated image data. The network communication unit 305 is a network I/F and performs transmission and reception of information such as the image data by way of wired communication or wireless communication. An image based on the image data received by the network communication unit 305 from the external apparatus can be printed by the print unit 307.

### Software Configuration

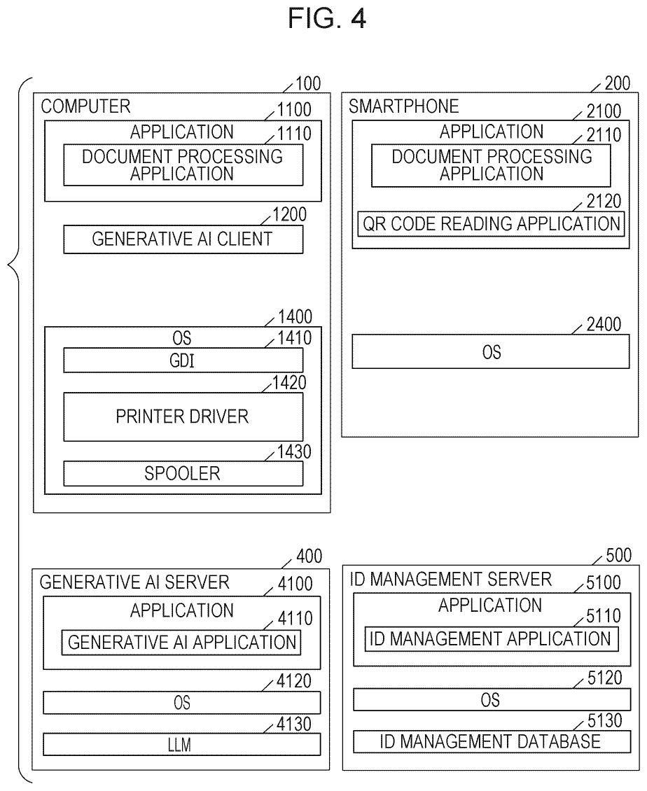

A software configuration of each of the apparatuses included in the printing system 10 will be described with reference to FIG. 4.

The computer 100 has an application 1100, a generative AI client 1200, and an operating system (OS) 1400. The application 1100 includes any software such as, for example, security software, spreadsheet software, or browser software and includes, in the example of FIG. 4, a document processing application 1110. The document processing application 1110 is an application which edits and displays content such as a text (sentence), a photograph, or chart data. There is no particular limitation on the document processing application 1110, and examples of the document processing application 1110 include spreadsheet software, browser software, and presentation software, for example.

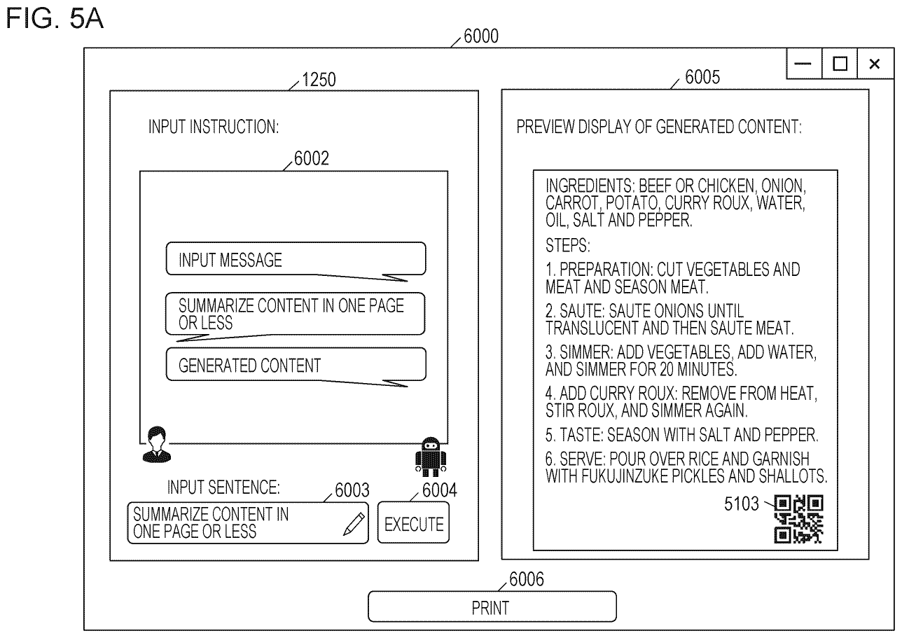

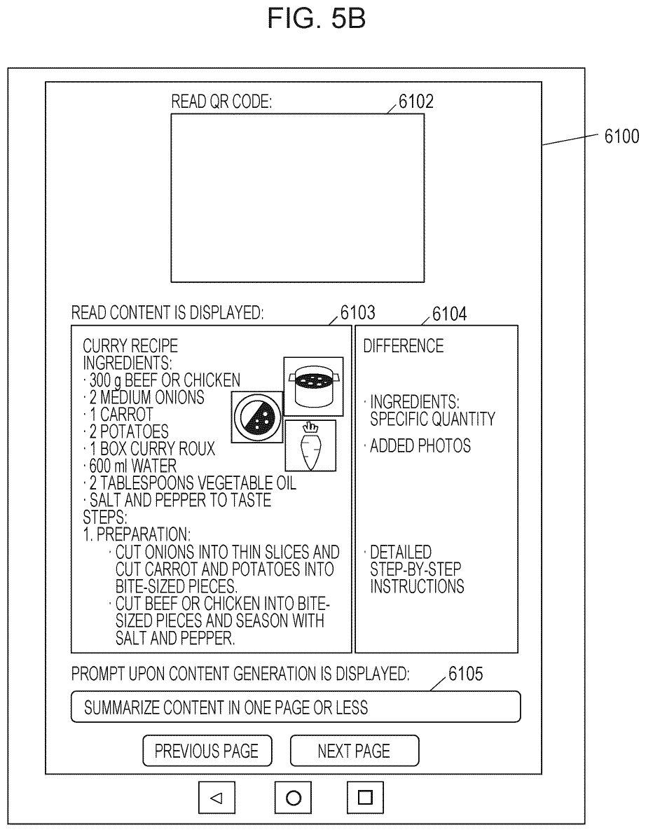

The generative AI client 1200 represents client software to be executed by the computer 100. The generative AI client 1200 accepts an input of an instruction sentence (prompt) from the user and generates such an instruction sentence for transmission as illustrated in FIG. 5A to transmit the instruction sentence for transmission to the generative AI server 400. Herein, the instruction sentence for transmission is obtained by adding an additional instruction to the instruction sentence that has been input from the user. It is noted that a combination of the generative AI server 400 and the generative AI client 1200 may be referred to as a generative AI system. In addition, in the present specification, content generation processing implemented by the generative AI system may be referred to as conversion processing.

The OS 1400 is software which executes a basic operation of the computer 100. The OS 1400 includes a GDI 1410, a printer driver 1420, and a spooler 1430. The printer driver 1420 is provided by a business operator which provides the OS 1400 or the MFP 300. Any of the application 1100, the printer driver 1420, and the like is managed by the OS 1400 and can be used when being installed into the OS 1400. In addition, the printer driver 1420 may be incorporated in the OS 1400 in advance.

The GDI 1410 is a component inside the OS 1400 which provides an interface related to rendering such as printing to the outside. The printer driver 1420 performs user interface (UI) display of a print setting for performing printing in the MFP 300. In addition, at the time of the printing, the printer driver 1420 generates rendering data (page description language: PDL) that is acceptable by the MFP 300. The spooler 1430 performs processing of transmitting the PDL generated by the printer driver 1420 towards the MFP 300.

It is noted that a configuration using Windows (registered trademark) of Microsoft (registered trademark) as an operating system (OS) has been described here, but other OSs may be used as the OS 1400. In addition, print data received by the printer driver 1420 from print application may be not only data in a GDI format but also data in an XML Paper Specification format (data in an XPS format).

It is noted that the generative AI client 1200 and the printer driver 1420, the GDI 1410, and the spooler 1430 may be installed in the OS 1400 as a single program.

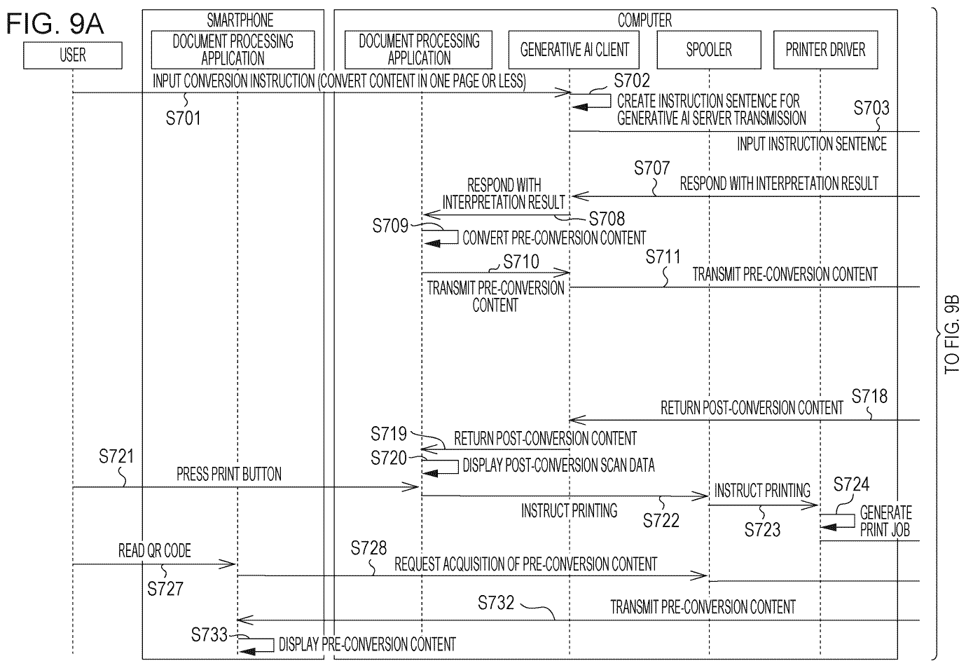

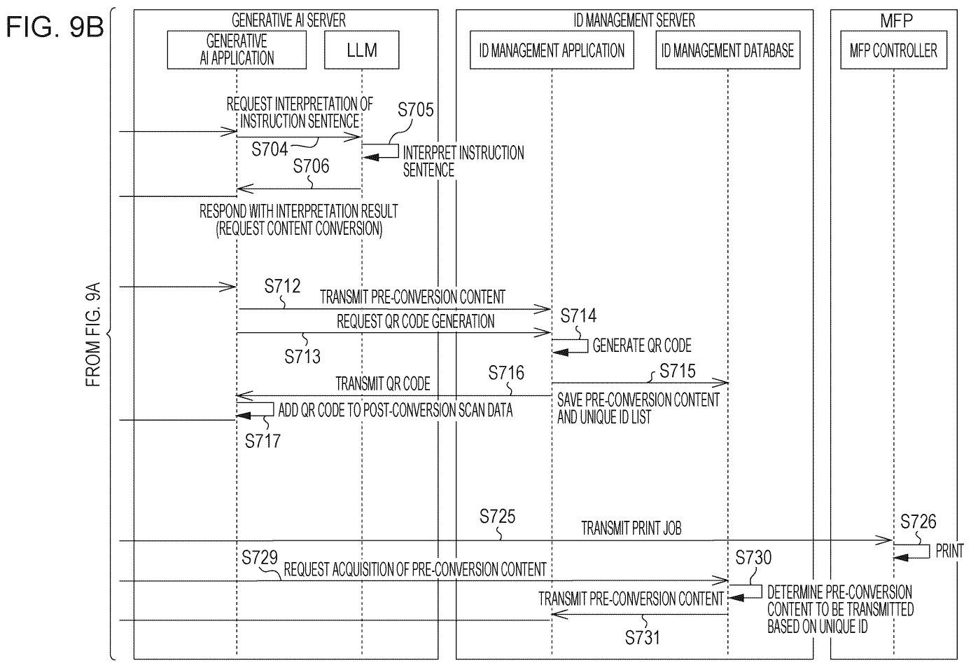

For example, according to the single program, an input of a prompt may be accepted from the user, the prompt that has been input and input image data may be transmitted to the generative AI server 400, or a screen 6000 of FIG. 5A may be displayed. In addition, all the processing of the computer 100 in a sequence of FIGS. 9A and 9B may be executed by a single application.

The smartphone 200 has an application 2100 and an OS 2400. It is noted that the OS 2400 is almost identical to the software configuration of the OS 1400, and therefore descriptions on the OS 2400 will be omitted herein. The application 2100 includes optional software and includes, in the example of FIG. 4, a document processing application 2110 and a QR code reading application 2120. Similarly as in the document processing application 1110, the document processing application 2110 is an application which edits and displays content such as a text (sentence), a photograph, or chart data. In addition, the QR code reading application 2120 is an application which has a function with which code information such as a QR code installed by the user can be read through a camera or the like built in the smartphone 200. It is noted that the QR code reading application 2120 can read not only a two-dimensional code but also a one-dimensional code such as a bar code.

The generative AI server 400 has an application 4100, an OS 4120, and a large language model (LLM) 4130. It is noted that the OS 4120 is almost identical to the software configuration of the OS 1400, and therefore descriptions on the OS 4120 will be omitted herein. The application 4100 includes optional software and includes, in the example of FIG. 4, a generative AI application 4110. The generative AI application 4110 is an application which has an interpretation processing function of generative AI. The generative AI application 4110 transmits, to the LLM 4130, the instruction sentence from the user which has been transmitted from the generative AI client 1200 and transmits, to the generative AI client 1200, a response sentence received from the LLM 4130. The LLM 4130 is a language model (learning model) in which leaning has been performed by data such as a large amount of text data. The LLM 4130 interprets the instruction sentence transmitted from the generative AI application 4110 and responds with an interpretation result to the generative AI application 4110. Examples of the LLM 4130 includes GPT-4, GPT-4o, Bert, a transformer model, and the like.

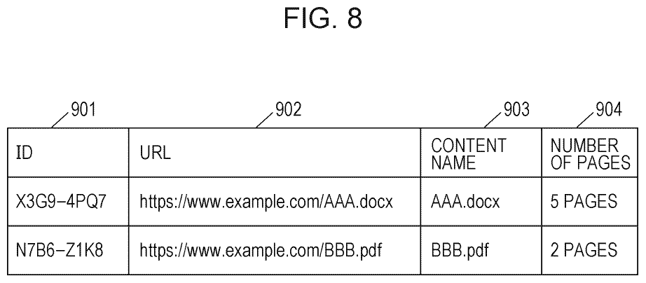

The ID management server 500 has an application 5100, an OS 5120, and an ID management database 5130. It is noted that the OS 5120 is almost identical to the software configuration of the OS 1400, and therefore descriptions on the OS 5120 will be omitted herein. The application 5100 includes optional software and includes, in the example of FIG. 4, an ID management application 5110. The ID management application 5110 generates an ID when an ID generation request is received from an optional application including the generative AI application 4110. Herein, the ID refers to a non-overlapping unique ID composed of one or more data values. The ID generated by the ID management application 5110 is saved in the ID management database 5130 or returned to the application. The ID management database 5130 saves data related to such IDs as illustrated in FIG. 8.

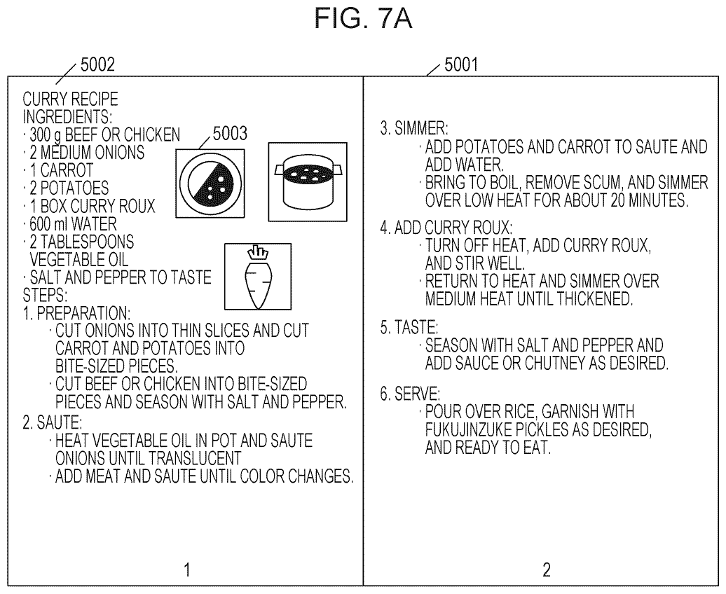

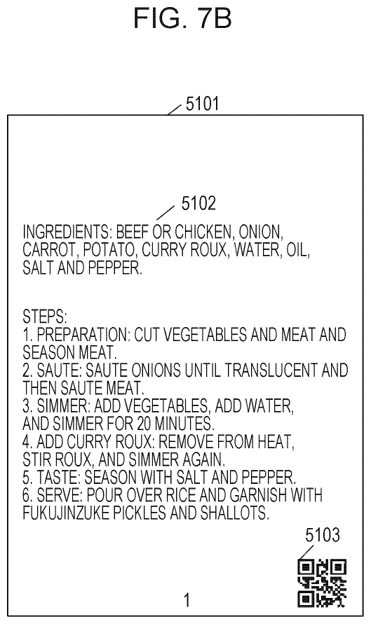

FIGS. 5A and 5B illustrate examples of the screen 6000 displayed on the display unit 101 by the document processing application 1110 of the computer 100 and a screen 6100 displayed on the smartphone 200. The document processing application 1110 displays the screen 6000 including a generative AI client UI 1250 which executes UI display in the generative AI client 1200. Furthermore, the document processing application 1110 displays the screen 6000 including a preview display section 6005 (image data display section) in which preview display of an image to be printed is performed and a print button 6006. The generative AI client UI 1250 includes a chat section 6002 which displays a message by the user to be transmitted and received between the generative AI client 1200 and the generative AI server 400. The generative AI client UI 1250 also includes a prompt input section 6003 (area display section) in which a prompt is input and an execution button 6004 for transmitting the input prompt or a prompt obtained by editing the input prompt to the generative AI server 400. In the chat section 6002, the prompt input (character string) by the user is displayed. Furthermore, the prompt is determined by the LLM 4130 of the generative AI server 400, and a message output as a response is also displayed. Since the user inputs the prompt to the prompt input section 6003 and clicks the execution button 6004, the document processing application 1110 transmits the instruction sentence to the generative AI server 400. The document processing application 1110 receives a conversion command output as the response to the prompt from the generative AI server 400, converts a document based on the conversion command, and displays the document after the editing in the preview display section 6005. As an example of the conversion processing, in a case where an instruction sentence “summarize content in one page or less” is transmitted, the document processing application 1110 converts content 5001 of FIG. 7A into content 5101 to be displayed. Then, when the user determines that the document after the editing is appropriate and the user presses the print button 6006, a print instruction including image data generated by the conversion, a setting for printing the image data, and the like is transmitted to the MFP 300. Then, an image based on the image data generated by the editing is printed. In this manner, the prompt input section 6003 that is an area for the user to input a prompt and the preview display section 6005 in which an image to which a QR code has been added are displayed on the same screen.

It is noted that an example has been described in which the document processing application 1110 converts the document (input image data) based on the conversion command received from the generative AI server 400, but is not limited to this. For example, by transmitting the prompt and the image data before editing (input image data) to the generative AI server 400, the document processing application 1110 may convert the image data based on the prompt and the image data which have been received by the generative AI server 400. Then, the converted image data may be transmitted to the document processing application 1110. In the above-described case, the document processing application 1110 displays the image data after the editing which has been received from the generative AI server 400 in the preview display section 6005.

It is noted that as described above, the generative AI client UI 1250, the preview display section 6005 in which the preview display of the image to be printed is performed, and the print button 6006 may be displayed by a single application installed in the computer 100. In other words, the processing of the document processing application 1110 and the processing of the generative AI client UI 1250 which have been described above may be executed by the single application. For example, an input of a prompt by the user, a selection of the execution button 6004, and a selection of the print button 6006 may be accepted by the single application. Furthermore, processing of transmitting the prompt and the input image data to the generative AI server 400 and receiving the image data generated through the conversion by the generative AI server 400 to display the image data in the preview display section 6005 may be executed.

An example of a UI displayed on the document processing application 2110 of the smartphone 200 is illustrated. The document processing application 2110 has an image reading section 6102 of the QR code reading application 2120, a pre-summary content display section 6103, a difference display section 6104, and a prompt display section 6105.

Video shot by a camera built in the smartphone 200 is displayed in the image reading section 6102, and the user captures a QR code in the video to read the QR code. Herein, the QR code includes some or all of data such as an ID 901 which will be described below in FIG. 8 and a uniform resource locator (URL) 902 to be stored in the storage unit 503 of the ID management server 500 and also may include other data. Then, the smartphone 200 transmits the ID included in the QR code to the ID management server 500 and receives content received from the ID management server 500 in the pre-summary content display section 6103. In a case where the QR code indicates a URL (information indicating a storage location of the image data), the smartphone 200 accesses a server indicated by the URL. Information received from the server is displayed in the pre-summary content display section 6103. In the pre-summary content display section 6103, the image data to which the QR code read by the camera has been added and the image data received from the ID management server 500 or the server indicated by the URL that is the image data before editing, summarizing, or the like is performed by the generative AI are displayed. In other words, the ID management server 500 or the server indicated by the URL stores the image data before the editing, the summarizing, or the like is performed by the generative AI. In other words, the code information such as the QR code added to the image data includes information indicating a storage location of the image data before being edited by the generative AI that is the image data input to the computer 100.

In the difference display section 6104, a part that is different between pre-summary content and post-summary content is displayed as a difference. In other words, the difference between the image data before being edited by the generative AI and the image data after being edited is displayed in the form of a text. With this configuration, the user can easily check what information is missing or is added or changed through the editing of the image data by the generative AI.

In the prompt display section 6105, a prompt input by the user is displayed when the document processing application 1110 implements processing of generating post-summary content from pre-summary content. In other words, a prompt used by the generative AI for the generative AI to generate the image data after the editing is displayed in the form of a text. In other words, in the display unit of the terminal apparatus which has read the code information such as the QR code, the image data input to the computer 100 and the prompt input by the user are displayed on the same screen. With this configuration, the user can easily check how the image data (original) generated by the generative AI is generated.

This prompt may be stored in a storage unit of any of the computer 100, the smartphone 200, the printer 300, the generative AI server 400, and the ID management server 500.

For example, the prompt may be stored in the ID management server 500 in association with the ID indicated by the QR code, and the smartphone 200 may receive the prompt from the ID management server 500. In addition, the prompt may be stored in the server in the storage location indicated by the URL indicated by the QR code together with the image data before editing (image data input to the computer 100), and the smartphone 200 may receive the prompt from the server in the storage location.

Furthermore, since the QR code is read, version information of the generative AI which has generated the image data after the editing may also be displayed on the screen 6100 of FIG. 5B which is displayed by the document processing application 2110. Similarly as in the prompt, this version information may be stored in the ID management server 500 or the server in the storage location indicated by the URL indicated by the QR code.

It is noted that all or some of various information displayed on the screen 6100 of FIG. 5B may be included in a code such as a QR code. In other words, not only a URL or an ID but also this version information of the generative AI, a prompt, and the like may be directly included in the information indicated by the QR code.

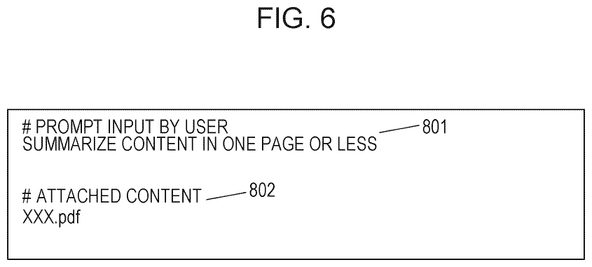

FIG. 6 illustrates an example of a prompt transmitted by the computer 100 to the generative AI server 400. The prompt is composed, for example, of a prompt 801 and attached content 802.

The prompt 801 includes the prompt input by the user to the prompt input section 6003 of the application 1110. In addition, in a case where the user desires to use a subject of the content saved in the storage unit 103 of the computer 100 as an input to the LLM of the generative AI server 400, the instruction sentence includes a file name and a path of the attached content 802.

FIGS. 7A and 7B illustrate an example of content before and after editing. Herein, content before and after editing performed by the generative AI for the prompt input by the user will be described. As the prompt input by the user to the prompt input section 6003, for example, an input of a prompt “summarize content in one page or less” is assumed. The content 5001 is content related to a curry recipe before editing and is image data including a text 5002, an illustration 5003, and the like. The content 5101 is content obtained when the content 5001 is summarized by the generative AI in which a text 5102 obtained by summarizing (abbreviating) the subject of the text 5002 that is a sentence included in the image is included, and the illustration 5003 is deleted. With this configuration, a curry recipe is represented in one page. In other words, the image generated by the generative AI is an image including a sentence generated by summarizing the sentence in the image (image before the editing) in the image data input to the computer 100. In addition, the image generated by the generative AI may be an image generated by deleting, out of a sentence and a photograph (illustration) in the image (image before the editing) of the image data input to the computer 100, the photograph.

The content 5101 includes a QR code 5103 in addition to a text 5102.

As described above, the QR code 5103 is information for accessing the image data before being edited (image data input to the computer 100) by the generative AI. In other words, image data is generated based on the prompt input by the user and the image data input to the computer 100. Then, image data of an image generated (obtained) by adding, to the image data, the code information for accessing the image data input to the computer 100 is output to (displayed on) the display unit 101 of the computer 100.

In a state that the image to which the code information has been added is displayed, an input of a prompt to designate an insertion position of the QR code into the prompt input section 6003 may be accepted from the user.

In the above-described case, the computer 100 transmits the input prompt to the generative AI server 400 to cause the generative AI server 400 to generate image data in which the QR code has been added to the position designated by the user. It is noted that in a case where the computer 100 adds the QR code, in a state that the image to which the code information has been added is displayed, when a button which is not illustrated in the drawing is selected by the user, the designation of the location of the QR code is accepted. Then, the computer 100 inserts the QR code into a position (lower right, upper right, lower left, upper left, or the like) corresponding to the selected button.

The generative AI server 400 may generate this image data to which the code information such as the QR code has been added. In a case where the generative AI server 400 generates the image data, the generative AI server stores the image data input to the computer 100 in a predetermined storage location and generates a QR code as information indicating the storage location. Then, the generative AI server 400 adds the generated QR code to the image data which has been edited from the image data input to the computer 100. The generative AI server 400 transmits the image data to which the QR code has been added to the computer 100. With this configuration, the image data (content 5101) to which the QR code has been added is displayed in the preview display section 6005 of the display unit 101 of the computer 100.

The computer 100 may generate this image data to which the code information such as the QR code has been added. In the above-described case, the computer 100 stores the image data input to the computer 100 in a predetermined storage location and generates a QR code as information indicating the storage location. Then, the generative AI server 400 transmits the image data input to the computer 100. Then, the image data generated through editing by the generative AI server 400 is received by the computer 100. The computer 100 generates image data by adding the QR code to the image of the received image data. With this configuration, the image data (content 5101) to which the QR code has been added is displayed in the preview display section 6005 of the display unit 101 of the computer 100. Then, the computer 100 transmits the print data of the image data of the image to which the code information has been added to the MFP 300. The print data transmitted herein includes the print setting accepted by the computer 100. The MFP 300 prints the image to which the code information has been added on a sheet based on the print setting included in the received print data. This processing corresponds to processes in S1724 to S1726 which will be described below. Through these processes, it is possible to output the image data of the image to which the code information has been added for accessing the image data input to the image generated by the generative AI by using the prompt which has been input and the input image data.

The MFP 300 may generate this image data to which the code information such as the QR code has been added. In the above-described case, the computer 100 stores the image data input to the computer 100 in a predetermined storage location and transmits information indicating the storage location to the MFP 300. Furthermore, the generative AI server 400 transmits, to the MFP 300, the print data including the image data which is obtained through the editing from the image data input to the computer 100 and then transmitted to the computer 100. With this configuration, the MFP 300 receives the image data after the editing and the code information indicating the storage location of the image data before editing. The MFP 300 then uses those pieces of information to generate the image data (content 5101) to which the QR code has been added and print the generated image data.

In FIG. 8, a ID list saved in the ID management database 5130 of the ID management server 500 will be described. The ID list includes information in association with contents, such as the ID 901, the URL 902, a content name 903, and a number of pages 904. The information is used as a search key when the content before the editing by the ID management server 500 is searched from the QR code read by the smartphone 200 or used as association information to be provided to the user.

In a column of the ID 901, identifiers “NXG9-4PQ7” and “N76-Z1K8” are described. In a column of the URL 902, URLs “https://www.example.com/AAA.docx” and “https://www.example.com/BBB.pdf” that are links for accessing respective pieces of data are included. In a column of the content name 903, document file names “AAA.docx” and “BBB.pdf” are described. In a column of the number of pages 904, the numbers of pages “5 pages” and “2 pages” for respective pieces of content are described. The ID management server 500 adds one row in the ID list when a QR code generation instruction is received from the generative AI server 400 and stores a series of information related to the content 5001 before the editing. That is, the ID included in the generated QR code is stored in the column of the ID 901, and the URL, the content name, and the number of pages of the content 5001 before the editing are respectively stored in the URL 902, the content name 903, and the number of pages 904.

When the user reads the QR code by the smartphone 200 and the ID management server 500 receives a transmission instruction of the content before the editing from the smartphone 200, a search for the content before the editing is performed based on an ID corresponding to the QR code read by the smartphone 200. Then, in a case where the relevant content is found, the content is returned to the smartphone 200. A detail will be described in an explanation of FIGS. 9A and 9B.

It is noted that in this explanation, an example has been described in which values such as the ID 901, the URL 902, the content name 903, and the number of pages 904 are saved in the ID list saved by the ID management server 500, but the values saved in the ID list are not limited to the above-described values. For example, values such as a content size, a content creator name, and organization information may be retained in the ID list.

It is noted that in this explanation, an embodiment has been described in which the search for the relevant content is performed from the ID list by using the ID 901, but a method of searching for the content is not limited to this. For example, in a case where the ID management server 500 stores data on previously searched content (referred to as previously searched data) in the storage unit 403 and the ID management server 500 learns a pattern from the previously searched data, the following configuration may be adopted. For example, the ID management server 500 may search for the content by using such a recommendation function.

In addition, in this explanation, an example has been described in which the search for the relevant content is implemented by collating only a single ID, but the search for the relevant content is implemented by using an ID that is not unique or using a plurality of IDs. Alternatively, a URL of a server in which the content before the editing is saved may be embedded in the QR code, and the search for the content before the editing may be performed based on the URL of the QR code read by the ID management server 500.

A processing procedure of the present embodiment in the printing system 10 according to the present embodiment will be described with reference to FIGS. 9A and 9B. Processing described below corresponds to a series of processes which starts from S701 in the illustrated sequence diagram.

In S701, the user inputs an instruction sentence (prompt) “convert content in one page or less” to the generative AI client 1200.

In S702, the CPU 141 of the computer 100 executes the generative AI client 1200, receives the prompt from the user, and creates an instruction sentence to be transmitted to the generative AI server 400.

In S703, the CPU 141 of the computer 100 executes the generative AI client 1200 and transmits the created instruction sentence to the generative AI application 4110 of the generative AI server 400.

In S704, the control unit 404 of the generative AI server 400 executes the generative AI application 4110 and requests the LLM 4130 to interpret the instruction sentence.

In S705, the control unit 404 of the generative AI server 400 controls the LLM 4130 to interpret the instruction sentence and generate an interpretation result. This interpretation result includes a content conversion request.

In S706, the control unit 404 of the generative AI server 400 controls the LLM 4130 to respond with the interpretation result to the generative AI application 4110.

In S707, the control unit 404 of the generative AI server 400 executes the generative AI application 4110 and responds with the interpretation result to the generative AI client 1200.

In S708, the CPU 141 of the computer 100 executes the generative AI client 1200 and responds with the interpretation result to the document processing application 1110.

In S709, the CPU 141 of the computer 100 executes the document processing application 1110 and performs editing based on the interpretation result from the content 5001 before the editing to the content 5101 after the editing. It is noted that the generative AI application 4110 of the generative AI server 400 may execute this editing processing. In the above-described case, the content 5101 after the editing which has been generated by the generative AI application 4110 is received and displayed by the computer 100.

In S710, the CPU 141 of the computer 100 executes the document processing application 1110 and transmits the content 5001 before the editing to the generative AI client 1200.

In S711, the CPU 141 of the computer 100 executes the generative AI client 1200 and transmits the content 5001 before the editing to the generative AI application 4110.

In S712, the control unit 404 of the generative AI server 400 executes the generative AI application 4110 and transmits the content 5001 before the editing to the ID management application 5110.

In S713, the control unit 404 of the generative AI server 400 executes the generative AI application 4110 and transmits a generation request of the QR code 5103 to the ID management application 5110.

In S714, the CPU 541 of the ID management server 500 executes the ID management application 5110 and generates the QR code 5103 in which the data including the ID is embedded.

It is noted that this QR code may be generated by the computer 100 may be generated by the generative AI server 400, or may be generated by the MFP 300 as described above. In addition, instead of the ID, the information indicated by the QR code may be a URL indicating a storage location of the image data. In these cases, some difference exists from the following flow, and information is to be exchanged between the above-described apparatuses.

In S715, the control unit 404 of the generative AI server 400 executes the generative AI application 4110 and saves the content 5001 before the editing and the ID list in the ID management database 5130.

In S716, the CPU 541 of the ID management server 500 executes the ID management application 5110 and transmits the generated QR code 5103 to the generative AI application 4110.

In S717, the control unit 404 of the generative AI server 400 executes the generative AI application 4110 and adds the QR code 5103 to the content 5101 after the editing.

In S718, the control unit 404 of the generative AI server 400 executes the generative AI application 4110 and returns the content 5101 after the editing to the generative AI client 1200.

In S719, the CPU 141 of the computer 100 executes the generative AI client 1200 and returns the content 5101 after the editing to the document processing application 1110.

In S720, the CPU 141 of the computer 100 executes the document processing application 1110 and displays the preview display section 6005 on the content 5101 after the editing.

In S721, the user presses the print button 6006 of the document processing application 1110.

In S722, the CPU 141 of the computer 100 executes the document processing application 1110 and transmits the print data to the spooler 1430. The print data to be transmitted here is as described above.

In S723, the CPU 141 of the computer 100 controls the spooler 1430 to transmit the print data to the printer driver 1420.

In S724, the CPU 141 of the computer 100 controls the printer driver 1420 to generate a print job.

In S725, the CPU 141 of the computer 100 controls the printer driver 1420 to transmit the print job to the MFP 300.

In S726, the MFP 300 prints the image on the sheet based on the received print job.

In S727, the user reads the QR code 5103 of the content by the QR code reading application 2120 of the smartphone 200.

In S728, a CPU 241 of the smartphone 200 executes the document processing application 2110 and transmits an acquisition request of the content 5001 before the editing to the ID management application 5110. The acquisition request includes the ID 901 of the read QR code.

In S729, the CPU 241 of the smartphone 200 executes the document processing application 2110. In addition, the CPU 541 of the ID management server 500 executes the ID management application 5110 and transmits the acquisition request of the content 5001 before the editing to the ID management database 5130.

In S730, the CPU 541 of the ID management server 500 controls the ID management database 5130 to determine the content 5001 before the editing which is to be transmitted based on the ID 901 obtained from the document processing application 2110.

In S731, the CPU 541 of the ID management server 500 controls the ID management database 5130 to transmit the content 5001 before the editing to the ID management application 5110.

In S732, the CPU 541 of the ID management server 500 controls the ID management application 5110 to transmit the content 5001 before the editing to the document processing application 2110.

In S733, the CPU 241 of the smartphone 200 executes the document processing application 2110 and displays the content 5001 before the editing which has been obtained in the display section 6103.

When the above-described processing procedure is implemented, the user can easily refer to the content before the editing from the content after the editing.

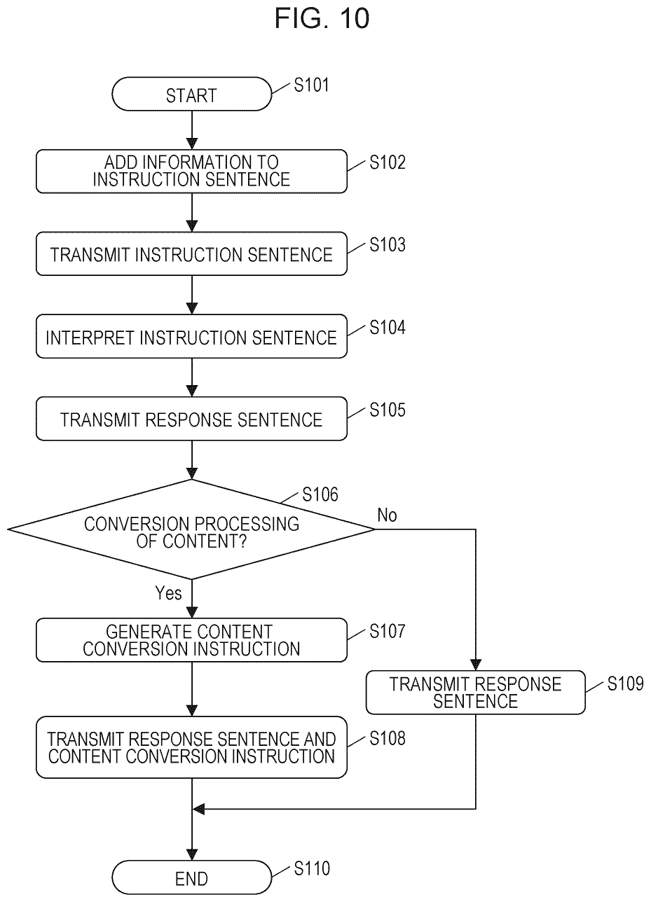

FIG. 10 is a flowchart illustrating an example of processing executed by the generative AI server 400. The processing described below is realized when, for example, the CPU 441 of the generative AI server 400 reads out the program stored in the storage unit 403 into the memory 442 for execution.

In S101, when the generative AI server 400 receives the instruction sentence (prompt 801) from the generative AI client 1200, the present processing is started. This instruction sentence is, for example, a subject “convert content in one page or less”.

In S102, the generative AI application 4110 of the generative AI server 400 adds appropriate information to the instruction sentence. For example, through a mechanism called retrieval-augmented generation (RAG) or system prompt, information such as information related to a content, apparatus model information, or organization information is added. With this configuration, an interpretation accuracy in the LLM 4130 is expected to be increased.

In S103, the generative AI application 4110 transmits the instruction sentence to the LLM 4130.

In S104, the LLM 4130 implements interpretation processing of the instruction sentence. Herein, the interpretation processing implemented by the LLM 4130 includes one or a plurality of processes among processes such as pre-processing of a text, tokenization and vectorization of the text, understanding of a context, text generation and prediction, and response sentence generation.

In S105, the LLM 4130 transmits the response sentence generated in S104 to the generative AI application 4110.

In S106, the generative AI application 4110 determines whether or not the received interpretation result is a subject related to the editing processing of the content. When it is determined that the received interpretation result is the subject related to the editing processing of the content, the generative AI application 4110 generates a conversion instruction of the content in S107 and transmits a response sentence and an editing instruction of the content to the generative AI client 1200 in S108. Then, the processing is ended in S110. In S106, when it is determined that the response sentence is not the subject related to the conversion processing of the content, the generative AI application 4110 does not generate a conversion instruction of the content but transmits only the response sentence to the generative AI client 1200 in S109, and the processing is ended in S110.

When the above-described processing is implemented, the generative AI server 400 can change the response sentence to be transmitted to the generative AI client 1200 depending on whether or not the prompt input by the user includes the editing instruction of the content. As a result, the generative AI client 1200 can provide the document processing application 1110 with a unit configured to determine whether or not the content is to be summarized.

As described above, the printing system according to the present embodiment includes the computer 100, the smartphone 200, the generative AI server 400 which provides the generative AI service, the ID management server 500 which provides the ID management service, and the MFP 300.

In one example, when the generative AI server 400 implements the editing processing of the content based on the prompt input by the user, the generative AI server 400 requests the ID management server 500 to generate and save a QR code. Then, the content to which the generated QR code has been attached is returned to the document processing application 1110, and printing of the post-summary content is implemented based on the print instruction of the user. Thereafter, since the user reads the QR code of the post-summary content by the smartphone 200, the search for the content before the editing of the ID management server 500 is performed, so that the user can easily refer to the content before the editing.

### Second Embodiment

According to a second embodiment, an embodiment will be described in a case where the MFP 300 has the generative AI client 1200, and the user converts, by using the generative AI system, the image scanned by the MFP 300.

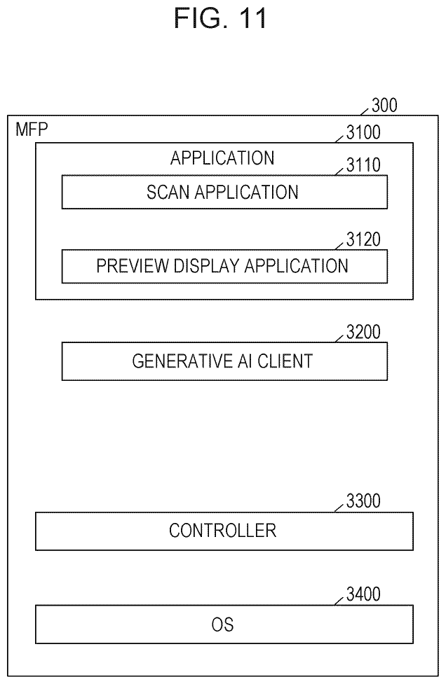

As illustrated in FIG. 11, the MFP 300 includes an application 3100, a generative AI client 3200, a controller 3300, and an OS 3400. The application 3100 includes optional software and includes, in the example of FIG. 11, a scan application 3110 which controls scan processing and a preview display application 3120 which controls preview display.

The generative AI client 3200 is an application which controls an operation of the scan unit 306. The generative AI client 3200 represents client software executed by the MFP 300. The generative AI client 3200 receives an instruction sentence (prompt) from the user and generates such an instruction sentence for transmission to the generative AI server 400 as illustrated in FIG. 5A to transmit the instruction sentence to the generative AI server 400.

The controller 3300 represents a controller configured to execute transmission and reception of data transmitted from the scan unit 306 or any computer, a network management function, or the like.

The OS 3400 is an OS that performs task management, memory management, file management, peripheral device management, or the like of the MFP 300.

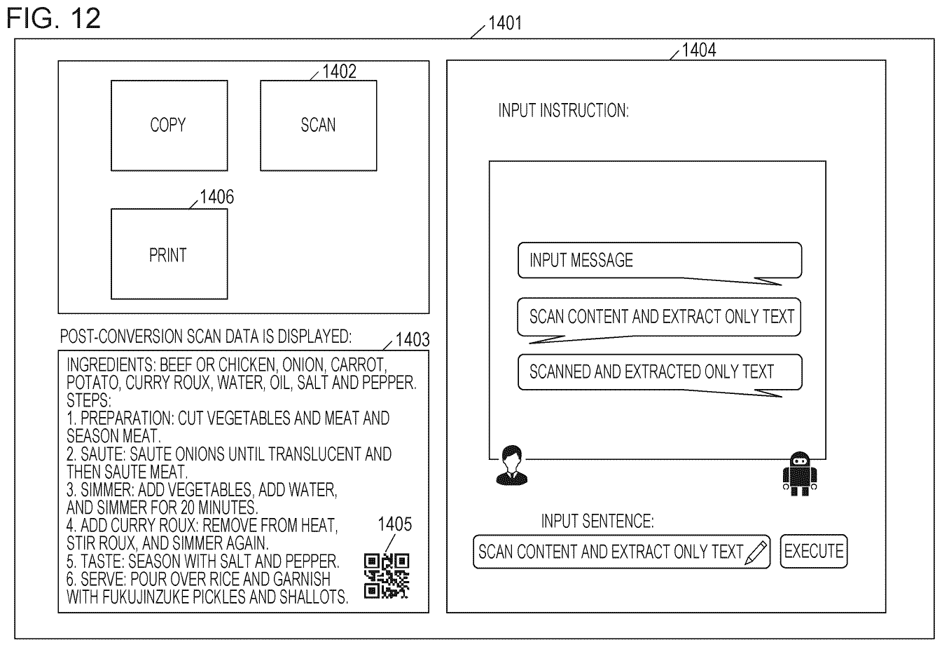

FIG. 12 is an example of a local user interface (LUI) 1401 displayed on the display unit 301 of the MFP 300.

The LUI 1401 has a scan button 1402, a preview display section 1403, a generative AI client UI 1404, and a print button 1406.

The scan button 1402 is a button, when selected, for the scan unit 306 to execute scanning of an original. The user sets a sheet desired to be scanned on a document positioning plate of the MFP 300 and presses the scan button 1402, so that the scan processing in the scan unit 306 is executed. It is noted that the scan unit 306 can also read an original placed on a glass plate and can also scan a conveyed original when the original placed on the document positioning plate is conveyed by an auto document feeder (ADF).

The print button 1406 is a button, when selected by the user, for printing an image on a sheet. The image printed herein is an image of the image data input to the MFP 300 by various methods. For example, the image data may be image data included in the print job received from the computer 100 or may be image data obtained from a USB memory. In addition, the image data may be image data stored in the storage unit 303 that is image data generated by scanning the original by the scan unit 306. The user sets a sheet desired to be used for the printing in the MFP 300 and presses the print button 1406, so that print processing in the print unit 307 is executed.

The preview display section 1403 can display any content such as image data generated by scanning the original by the scan unit 306 or content after the image data is processed by the generative AI. In the example of FIG. 12, an image of the image data after being processed by the generative AI and the QR code 1405 indicating information corresponding to the image data before being processed by the generative AI are displayed.

Since the generative AI client UI 1404 has a configuration similar to that of the generative AI client UI 1250, a description thereof will be omitted.

When the user implements the press of the scan button 1402 and the input of the prompt in the generative AI client UI 1404, a configuration is attained in which new data based on the image data generated through the scanning can be generated.

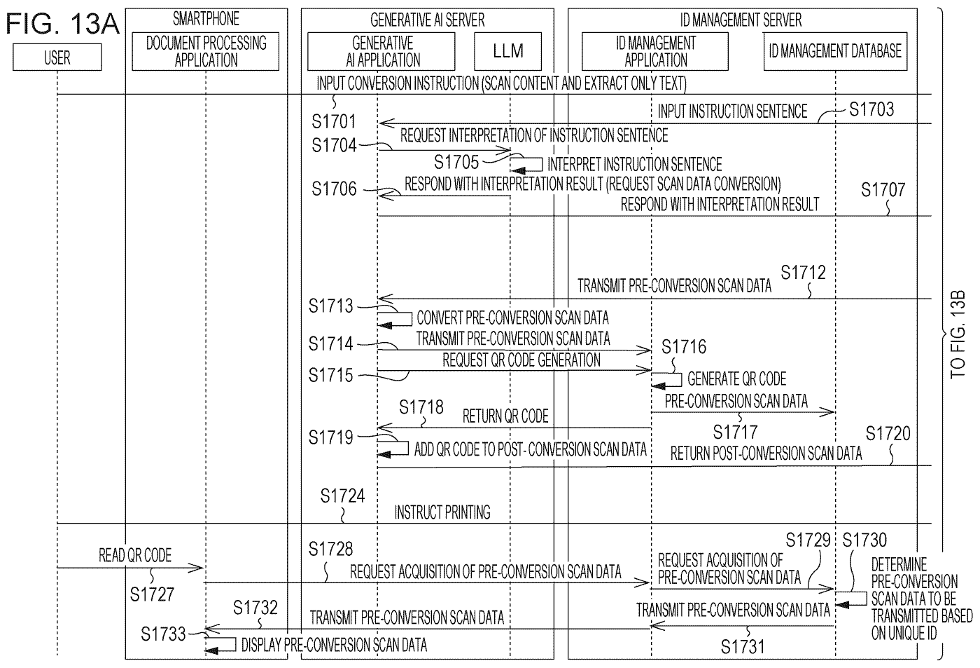

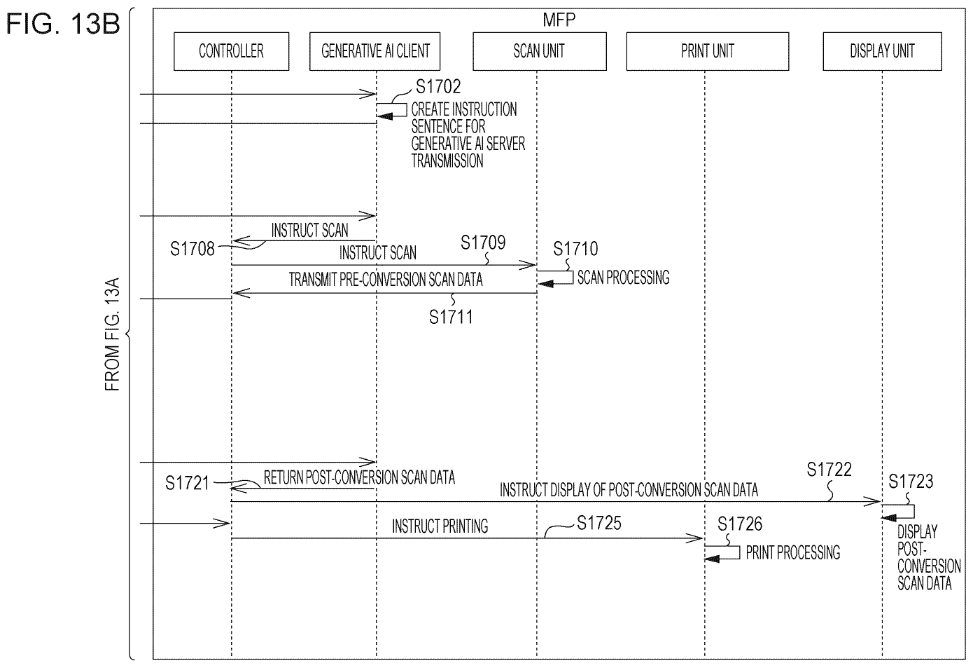

A processing procedure of the present embodiment in the printing system 10 according to the present embodiment will be described with reference to FIGS. 13A and 13B.

In S1701, the user inputs an instruction sentence (prompt) “scan content and extract only text” to the generative AI client 3200 of the MFP 300. It is noted that at this time, the user inputs the above-described prompt in a state that the original is placed on a document positioning plate of the scan unit 306.

In S1702, the CPU 341 of the MFP 300 executes the generative AI client 3200, receives the prompt from the user, and creates an instruction sentence to be transmitted to the generative AI server 400.

In S1703, the CPU 341 of the MFP 300 executes the generative AI client 3200 and transmits the created instruction sentence to the generative AI application 4110 of the generative AI server 400.

In S1704, the control unit 404 of the generative AI server 400 executes the generative AI application 4110 and requests the LLM 4130 to interpret the instruction sentence.

In S1705, the control unit 404 of the generative AI server 400 controls the LLM

4130 to interpret the instruction sentence and generate an interpretation result. This interpretation result includes a content conversion request.

In S1706, the control unit 404 of the generative AI server 400 controls the LLM 4130 to respond with the interpretation result to the generative AI application 4110.

In S1707, the control unit 404 of the generative AI server 400 executes the generative AI application 4110 and responds with the interpretation result to the generative AI client 3200.

In S1708, the CPU 341 of the MFP 300 executes the generative AI client 3200 and transmits a scan instruction to the controller 3300 based on the interpretation result.

In S1709, the CPU 341 of the MFP 300 controls the controller 3300 to transmit the scan instruction to the scan unit 306.

In S1710, the CPU 341 of the MFP 300 controls the scan unit 306 to perform scan processing of an original placed on a document positioning plate of the MFP 300.

In S1711, the CPU 341 of the MFP 300 controls the scan unit 306 to transmit scan data (image data generated through scanning) to the controller 3300. As this scan data, an image file itself of the scanned image data may be transmitted. In addition, optical character recognition (OCR) processing may be executed on the image data to obtain a character string and transmit the obtained character string (text data).

In S1712, the CPU 341 of the MFP 300 controls the controller 3300 to transmit the scan data before the editing to the generative AI application 4110.

In S1713, the control unit 404 of the generative AI server 400 executes the generative AI application 4110 and implements the editing processing of the scan data before the editing based on the prompt. For example, for a prompt “scan content and extract only text”, the generative AI application 4110 performs processing of extracting only a text from scan data and generating image data.

In S1714, the control unit 404 of the generative AI server 400 executes the generative AI application 4110 and transmits the scan data before the editing to the ID management application 5110.

In S1715, the control unit 404 of the generative AI server 400 executes the generative AI application 4110 and transmits the QR code generation request to the ID management application 5110.

In S1716, the CPU 541 of the ID management server 500 executes the ID management application 5110 and generates the QR code 5103 in which the data including the ID is embedded. It is noted that it is sufficient when the QR code generated herein indicates information for accessing the scan data before the editing similarly as in the first embodiment. For example, the information may be a URL indicating a storage location in which the scan data before the editing is stored.

In S1717, the control unit 404 of the generative AI server 400 executes the generative AI application 4110 and saves the scan data before the editing and the ID list in the ID management database 5130.

In S1718, the CPU 541 of the ID management server 500 executes the ID management application 5110 and transmits the generated QR code 5103 to the generative AI application 4110.

In S1719, the control unit 404 of the generative AI server 400 executes the generative AI application 4110 and adds the QR code 5103 to the scan data after the editing.

In S1720, the control unit 404 of the generative AI server 400 executes the generative AI application 4110 and returns the scan data after the editing to the generative AI client 3200.

In S1721, the CPU 341 of the MFP 300 executes the generative AI client 3200 and returns the scan data after the editing to the controller 3300.

In S1722, the CPU 341 of the MFP 300 controls the controller 3300 to transmit the scan data after the editing and a display instruction of the scan data after the editing to the display unit 301.

In S1723, the CPU 341 of the MFP 300 controls the display unit 301 to display the scan data after the editing to which the generated QR code has been added in the preview display section 1403.

In S1724, the user presses the print button 1406 to transmit the print instruction of the scan data after the editing displayed in the preview display section 1403 to the controller 3300.

In S1725, the CPU 341 of the MFP 300 controls the controller 3300 to transmit the print instruction of the scan data after the editing to the print unit 307.

In S1726, the CPU 341 of the MFP 300 controls the print unit 307 to execute print processing of printing the image of the image data that is the scan data after the editing on the sheet. It is noted that the user can input a print setting via the LUI 1401 (setting acceptance section) at any timing.

In S1727, the user reads the QR code 5103 printed on the sheet in S1726 by the QR code reading application 2120 of the smartphone 200.

In S1728, the CPU 241 of the smartphone 200 executes the document processing application 2110 and transmits the acquisition request of the scan data before the editing to the ID management application 5110.

In S1729, the CPU 541 of the ID management server 500 executes the ID management application 5110 and transmits the acquisition request of the scan data before the editing to the ID management database 5130.

In S1730, the CPU 541 of the ID management server 500 controls the ID management database 5130 to determine the scan data before the editing which is to be transmitted based on the ID 901.

In S1731, the CPU 541 of the ID management server 500 controls the ID management database 5130 to transmit the scan data before the editing to the ID management application 5110.

In S1732, the CPU 541 of the ID management server 500 executes the ID management application 5110 and transmits the scan data before the editing to the document processing application 2110.

In S1733, the CPU 241 of the smartphone 200 executes the document processing application 1110 and displays the scan data before the editing which has been obtained in the display section 6103.

The processing procedure of the present embodiment in the printing system 10 according to the present embodiment has been described above. When the above-described processing procedure is implemented, the user can seamlessly implement the scan processing and the data conversion processing with regard to the original set in the MFP 300.

In the first embodiment and the second embodiment, the printing system according to the present embodiment has been described above. It is noted however that the present disclosure is not limited to the above-described embodiments, and various modifications and alterations can be made within a scope of the gist. The present disclosure can also be realized by processing in which a program which realizes one or more functions of the above-described embodiments is supplied to a system or an apparatus via a network or a storage medium, and one or more processors of a computer of the system or the apparatus reads out the program for execution. In addition, the present disclosure may be realized by a circuit which realizes one or more functions (for example, an application specific integrated circuit (ASIC)).

In addition, in the above-described embodiments, the computer 100 or the MFP 300 has an operation unit configured to input an output condition in the MFP 300. However, the present disclosure is not limited to this, and it is sufficient when at least one apparatus among the computer 100, the smartphone 200, the MFP 300, the generative AI server 400, and the ID management server 500 has the operation unit. The operation unit may be displayed on a browser UI such as Microsoft (registered trademark) Edge or Google (registered trademark) Chrome. In addition, the operation unit may be displayed on a generative type application UI such as ChatGPT, a print application UI such as Microsoft (registered trademark) Office, or a chat application UI such as Microsoft Teams.

In addition, in the above-described embodiments, as print setting data saved in the storage unit, in actuality, it is conceivable that data formats for transmission and reception may be different such as PrintTicket and devmode depending on differences of the OS 1400 and the printer driver 1420. the present disclosure can be applied to the transmission and reception in such a variety of data formats too. Furthermore, in the above-described embodiments, it is described that in S637, the printer driver 1420 transmits the print job to the MFP 300 connected to the same network 600 as that of the computer 100. However, the present disclosure is not limited to this. For example, a configuration may be adopted in which in S725, the printer driver 1420 uploads the print job onto a print service on a cloud or the like and performs the printing by a printer connected to a network different from that of the computer 100 via the cloud.

In addition, in the printing system 10, for example, the generative AI server 400 (hereinafter, referred to as a “server”) may exist outside Japan and the computer 100 serving as a terminal apparatus (hereinafter, referred to as a “terminal apparatus”) may exist in Japan. In this case too, each file and data can be transmitted from the server to the terminal apparatus, and the terminal apparatus can receive each file and the data. In this manner, even in a case where the server exists outside Japan, the transmission and the reception (transmission and reception process) of the file and the data in this system is integrally performed. Then, since the system functions by receiving each file and the data from the terminal apparatus in Japan, it can be considered that the transmission and reception process is performed in Japan. In this system, for example, even when the server exists outside Japan and the terminal apparatus exists in Japan, the terminal apparatus can perform a main function of this system and can also express effects based on the function in Japan.

For example, even when the server exists outside Japan, if the terminal apparatus that constitutes this system exists in Japan, it is possible to use the system domestically by using the terminal apparatus. Then, the use of the system may affect the economic interests of the patent holder, for example.

In addition, the description has been provided of the method of creating the content by the document processing application 1110 in the above-described embodiments. However, the present disclosure is not limited to this, and the content is not created by the document processing application 1110, and for example, the content saved in the storage unit 103 of the computer 100 may be retrieved or the content may be retrieved from an external storage device such as a USB or an SD card.

In addition, according to the present embodiment, the document processing application 1110 and the generative AI client 3200 have been described as separate configurations, but the processing of the generative AI client 1200 may be included in the document processing application 1110.

In addition, it has been described that the printer driver 1420 displays a print preview image in the above-described first embodiment. However, the print preview image may be displayed according to a different program having a print preview image display function. For example, the document processing application 1110 may display the print preview image. The present disclosure is not restricted to the above-described embodiments, and various modifications and alterations can be made without departing from the spirit and the scope of the disclosure.

According to the aspect of the present disclosure, it is possible to refer to the original image of the image generated by the generative AI from the image generated by the generative AI.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-157265, filed Sep. 11, 2024, which is hereby incorporated by reference herein in its entirety.

What is claimed is:

1. A non-transitory computer readable storage medium storing a program that when executed by a processor of an information processing apparatus, causes the information processing apparatus to execute:
accepting an input of a prompt by a user; and
outputting image data generated by adding code information to an image generated by generative AI that uses the input prompt and input image data, wherein the code information provides access to the input image data.

2. The non-transitory computer readable storage medium according to claim 1, wherein execution of the stored program further causes the information processing apparatus to execute transmitting, to a printing apparatus, print data including the image data of the image to which the code information has been added.

3. The non-transitory computer readable storage medium according to claim 2, wherein execution of the stored program further causes the information processing apparatus to execute accepting a print setting, and
the print data includes the image data of the image to which the code information has been added and the print setting.

4. The non-transitory computer readable storage medium according to claim 1, wherein execution of the stored program further causes the information processing apparatus to execute:
displaying an area on a screen that accepts the input of the prompt; and
displaying the image to which the code information has been added, wherein
the area and the image to which the code information has been added are displayed on the same screen.

5. The non-transitory computer readable storage medium according to claim 4, wherein execution of the stored program further causes the information processing apparatus to
accept an input of a prompt by the user to designate a position in which the code information is to be added to the image in a state that the image to which the code information has been added is displayed.

6. The non-transitory computer readable storage medium according to claim 1, wherein
the code information includes information indicating a storage location of the input image data.

7. The non-transitory computer readable storage medium according to claim 6, wherein
the information indicating the storage location is a URL.

8. The non-transitory computer readable storage medium according to claim 6, wherein
the prompt that has been input is also stored in the storage location, and
the input image data and the prompt that has been input are displayed on a display unit of a terminal apparatus that has read the code information.

9. The non-transitory computer readable storage medium according to claim 6, wherein
version information of the generative AI is also included in the storage location, and
the input image data and the version information are displayed on a display unit of a terminal apparatus that has read the code information.

10. The non-transitory computer readable storage medium according to claim 1, wherein
the code information is a QR code.

11. The non-transitory computer readable storage medium according to claim 1, wherein execution of the stored program further causes the information processing apparatus to execute:
transmitting the prompt that has been input and the input image data to a generative AI server which provides the generative AI;
receiving image data of an image generated by the generative AI server; and
adding the code information to the image of the image data which has been received.

12. The non-transitory computer readable storage medium according to claim 1, wherein
the image generated by the generative AI is an image including a sentence generated by summarizing a sentence in an image of the input image data.

13. The non-transitory computer readable storage medium according to claim 1, wherein
the image generated by the generative AI is an image generated by deleting, out of a sentence and a photograph in an image of the input image data, the photograph.

14. An information processing apparatus, comprising:
at least one memory storing instructions; and
at least one processor that, upon execution of the stored instructions, configures the at least one processor to operate as:
an acceptance unit configured to accept an input of a prompt by a user; and
an output unit configured to output image data generated by adding code information to an image generated by generative AI that uses the input prompt and input image data, wherein the code information provides access to the input image data.

15. The information processing apparatus according to claim 14, wherein the at least one processor is configured to further operate as:
a transmission unit configured to transmit, to a printing apparatus, print data including the image data of the image to which the code information has been added.

16. The information processing apparatus according to claim 15, wherein the at least one processor is configured to further operate as:
a setting acceptance unit configured to accept a print setting, wherein
the print data includes the image data of the image to which the code information has been added and the print setting.

17. The information processing apparatus according to claim 14, wherein the at least one processor is configured to further operate as:
an area display unit configured to display an area on a screen that accepts the input of the prompt; and
an image data display unit configured to display the image to which the code information has been added, and
the area and the image to which the code information has been added are displayed on the same screen.

18. The information processing apparatus according to claim 14, wherein
the acceptance unit accepts an input of a prompt by the user to designate a position in which the code information is to be added to the image in a state that the image to which the code information has been added is displayed.

19. The information processing apparatus according to claim 14, wherein
the code information includes information indicating a storage location of the input image data.

20. The information processing apparatus according to claim 19, wherein
the information indicating the storage location is a URL.

21. The information processing apparatus according to claim 19, wherein
the prompt that has been input is also stored in the storage location, and
the input image data and the prompt that has been input are displayed on a display unit of a terminal apparatus that has read the code information.

22. The information processing apparatus according to claim 19, wherein
version information of the generative AI is also included in the storage location, and
the input image data and the version information are displayed on a display unit of a terminal apparatus that has read the code information.

23. The information processing apparatus according to claim 14, wherein
the code information is a QR code.

24. The information processing apparatus according to claim 14, wherein the at least one processor is configured to further operate as:
transmitting the prompt that has been input and the input image data to a generative AI server which provides the generative AI;
a reception unit configured to receive image data of an image generated by the generative AI server; and
an addition unit configured to add the code information to the image of the image data which has been received.

25. The information processing apparatus according to claim 14, wherein
the image generated by the generative AI is an image including a sentence generated by summarizing a sentence in an image of the input image data.

26. The information processing apparatus according to claim 14, wherein
the image generated by the generative AI is an image generated by deleting, out of a sentence and a photograph in an image of the input image data, the photograph.

27. An information processing method, comprising:
accepting an input of a prompt by a user; and
outputting image data generated by adding code information to an image generated by generative AI that uses the input prompt and input image data, wherein the code information provides access to the input image data.
